(19) United States
(12) Patent Application Publication
(10) Pub. No.: US 2010/0214399 A1
(43) Pub. Date: Aug. 26, 2010

(54) IMAGE CAPTURING APPARATUS

(75) Inventors: Hiroshi YAMAGUCHI, (US); Azuchi Endo, (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/711,006

(22) Filed: Feb. 23, 2010

(30) Foreign Application Priority Data
Feb. 25, 2009 (JP) 2009-042501

(51) Int. Cl. H04N 7/18; H04N 5/225

(52) U.S. Cl. 348/68; 348/340; 348/E05.024; 348/E07.085

(57) ABSTRACT

There is provided an image capturing apparatus including a light splitting section that splits light from an object into first light and second light in such a manner that (i) a split ratio of light in a specified wavelength range is different from a split ratio of light in a non-specified wavelength range and (ii) the second light has a smaller amount of light than the first light in the specified wavelength range, a high-sensitivity imaging element that receives the first light, and a low-sensitivity imaging element that receives the second light, where the low-sensitivity imaging element has a lower sensitivity than the high-sensitivity imaging element.

### CROSS REFERENCE TO RELATED APPLICATION

The present application claims priority from a Japanese Patent Application No. 2009-042501 filed on Feb. 25, 2009, the contents of which are incorporated herein by reference.

### BACKGROUND

1. Technical Field

The present invention relates to an image capturing apparatus for capturing fluorescence images and normal images.

2. Description of the Related Art

Japanese Patent Application Publication No. 2002-165751 discloses a technique of using a switching mirror in order that images are captured by means of an imaging element for normal light in the case of normal light and by means of a high-sensitivity imaging element for fluorescence in the case of fluorescence.

According to the above-mentioned technique in the related art, the imaging element for normal light is not in use while fluorescence images are captured, and the imaging element for fluorescence is not in use while normal images are captured. Thus, the related art technique does not make effective use of the unused imaging element.

### SUMMARY

Therefore, it is an object of an aspect of the innovations herein to provide an image capturing apparatus which is capable of overcoming the above drawbacks accompanying the related art. The above and other objects can be achieved by combinations described in the independent claims. The dependent claims define further advantageous and exemplary combinations of the innovations herein.

According to the first aspect related to the innovations herein, one exemplary imaging element may include a light splitting section that splits light from an object into first light and second light in such a manner that (i) a split ratio of light in a specified wavelength range is different from a split ratio of light in a non-specified wavelength range and (ii) the second light has a smaller amount of light than the first light in the specified wavelength range, a high-sensitivity imaging element that receives the first light, and a low-sensitivity imaging element that receives the second light, the low-sensitivity imaging element having a lower sensitivity than the high-sensitivity imaging element.

The light splitting section may split the light from the object into the first light and the second light in such a manner that the second light has a smaller amount of light in the specified wavelength range than the first light and the second light has substantially the same amount of light as the first light in the non-specified wavelength range.

The image capturing apparatus may further include an emitting section that emits excitation light to excite fluorescence having the specified wavelength range, and an excitation light cut filter that is positioned between the light splitting section and the high-sensitivity imaging element, where the excitation light cut filter removes a wavelength range of the excitation light. Here, the high-sensitivity imaging element may receive the fluorescence that has passed through the excitation light cut filter.

The image capturing apparatus may further include a fluorescence image generating section that generates a fluorescence image from the first light received by the high-sensitivity imaging element, when the emitting section emits the excitation light, and a background image generating section that generates a background image from the second light received by the low-sensitivity imaging element, when the emitting section emits the excitation light.

The emitting section may switch light emitted therefrom between the excitation light and white light, and the image capturing apparatus may further include a normal image generating section that generates a normal image from the first light received by the high-sensitivity imaging element and the second light received by the low-sensitivity imaging element, when the emitting section emits the white light.

The normal image generating section may generate the normal image based on (i) pixels, in an image captured by the high-sensitivity imaging element, whose luminance is equal to or lower than a predetermined luminance and (ii) pixels, in an image captured by the low-sensitivity imaging element, whose luminance is higher than the predetermined luminance.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates an image capturing apparatus 100 relating to an embodiment of the present invention.

FIG. 2 illustrates an example of a rotating filter 109.

FIG. 3 illustrates an exemplary positional relationship between a light source 108 and the rotating filter 109.

FIG. 4 illustrates an example of an image capturing section 112 provided within an end portion 121 of an endoscope 101.

FIG. 5 illustrates, as an example, how a light splitting section 141 splits light and how an excitation light cut filter 142 transmits light when an emitting section 106 emits white light.

FIG. 6 illustrates, as an example, how the light splitting section 141 splits light and how the excitation light cut filter 142 transmits light when the emitting section 106 emits excitation light.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

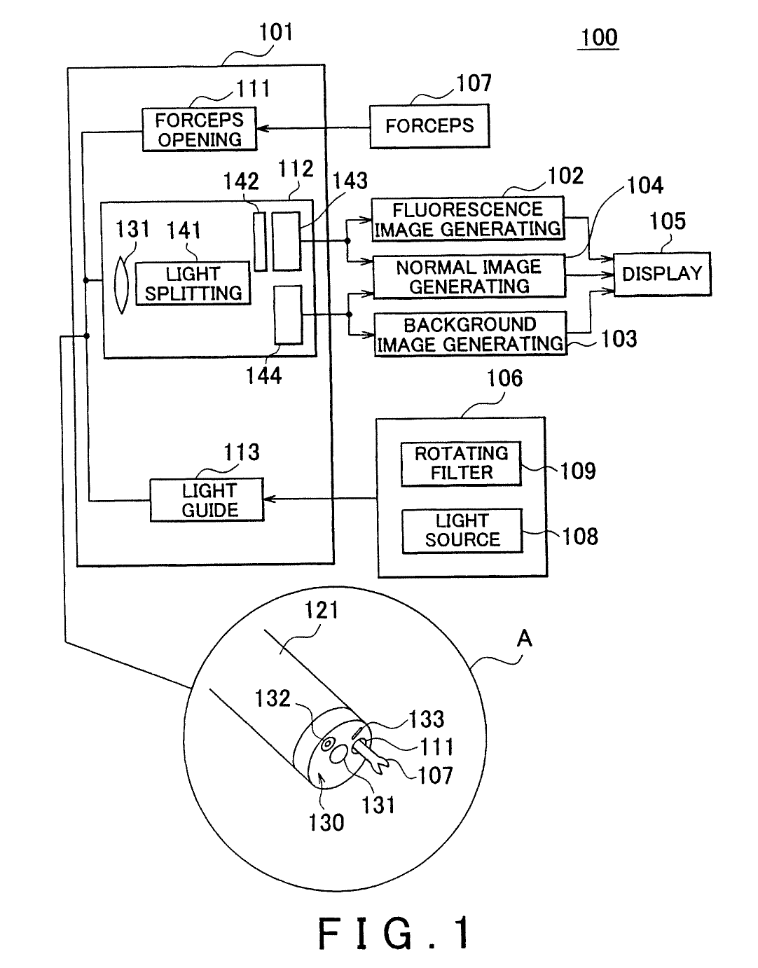

FIG. 1 illustrates an image capturing apparatus 100 relating to an embodiment of the present invention. The present embodiment will be described assuming a case where the image capturing apparatus 100 is applied, for example, to an endoscope system. The image capturing apparatus 100 includes an endoscope 101, a fluorescence image generating section 102, a background image generating section 103, a normal image generating section 104, a display section 105, an emitting section 106, and a forceps 107. The portion designated by a reference sign of “A” in FIG. 1 is an enlarged view of an end portion 121 of the endoscope 101.

The endoscope 101 includes a forceps opening 111, an image capturing section 112, and a light guide 113. The end portion 121 of the endoscope 101 has, on an end surface 130 thereof, a lens 131 that is part of the image capturing section 112. The end portion 121 also has, on the end surface 130 thereof, an exit 132 that is part of the light guide 113.

The emitting section 106 emits light towards an object. The emitting section 106 emits white light towards the object. The emitting section 106 emits excitation light. Here, the white light is an example of visible light having a wider wavelength range than the excitation light. The emitting section 106 includes a light source 108 and a rotating filter 109. The light source 108 emits the white light. The light source 108 may be a light bulb or LED. The rotating filter 109 includes a first filter transmitting white light and a second filter transmitting excitation light. The emitting section 106 switches the light to be emitted therefrom towards the object between the white light and the excitation light by rotating the rotating filter 109. The emitting section 106 emits the excitation light to excite fluorescence of a specified wavelength range. In other words, the wavelength range of the fluorescence excited by the excitation light emitted from the emitting section 106 is the specified wavelength range. The emitting section 106 emits the white light when the image capturing apparatus 100 is in a normal mode. On the other hand, the emitting section 106 emits the excitation light when the image capturing apparatus 100 is in a fluorescence mode. Alternatively, the end portion 121 of the endoscope 101 may have therein an LED emitting the white light and another LED emitting the excitation light. In this case, the white light and the excitation light may be emitted towards the object by causing the LEDs to emit light.

The light guide 113 is formed, for example, by an optical fiber. The light guide 113 guides the light emitted from the emitting section 106 to the end portion 121 of the endoscope 101. The light emitted from the emitting section 106 passes through the light guide 113 and is emitted from the exit 132 at the end surface 130, to be applied to the object.

The image capturing section 112 is positioned within the end portion 121 of the endoscope 101. The image capturing section 112 includes a lens 131, a light splitting section 141, an excitation light cut filter 142, a high-sensitivity imaging element 143, and a low-sensitivity imaging element 144. Here, the low-sensitivity imaging element 144 has a lower sensitivity than the high-sensitivity imaging element 143. The light splitting section 141 splits light from an object into first light and second light in such a manner that (i) a split ratio of light in a specified wavelength range is different from a split ratio of light in a non-specified wavelength range and (ii) the second light has a smaller amount of light than the first light in the specified wavelength range. The light splitting section 141 may split the light from the object into the first light and the second light in such a manner that the second light has a smaller amount of light in the specified wavelength range than the first light and the second light has substantially the same amount of light as the first light in the non-specified wavelength range. The light splitting section 141 can be obtained by combining together the techniques of interference filters and multilayer filters. The excitation light cut filter 142 removes light whose wavelength range matches the wavelength range of the excitation light emitted from the emitting section 106.

The high-sensitivity imaging element 143 receives first light transmitted by the excitation light cut filter 142. The low-sensitivity imaging element 144 receives second light produced by the light splitting section 141. The image capturing section 112 may include an imaging element driver that drives the high-sensitivity and low-sensitivity imaging elements 143 and 144, an AD converter, and some other constituents. The imaging element driver reads the amount of the light received by the high-sensitivity imaging element 143 and the amount of the light received by the low-sensitivity imaging element 144. The AD converter converts, into digital signals, the image information read from the high-sensitivity imaging element 143 and the image information read from the low-sensitivity imaging element 144. The imaging element driver, AD converter and the other constituents are controlled by an information processing apparatus such as a CPU. The information processing apparatus may be provided within the image capturing section 112 or within the image capturing apparatus 100.

The fluorescence image generating section 102 generates a fluorescence image from the light received by the high-sensitivity imaging element 143, when the emitting section 106 emits the excitation light. The background image generating section 103 generates a background image from the light received by the low-sensitivity imaging element 144, when the emitting section 106 emits the excitation light. Here, the functional block including the fluorescence image generating section 102 and the background image generating section 103 is an exemplary image generating section that generates a first image of the object from the light received by the high-sensitivity imaging element 143 and generates a second image of the object from the light received by the low-sensitivity imaging element 144. The normal image generating section 104 generates a normal image from the light received by the high-sensitivity imaging element 143 and the light received by the low-sensitivity imaging element 144, when the emitting section 106 emits the white light. Here, the functional block including the normal image generating section 104 is an exemplary image generating section that generates an image of the object from the light received by the high-sensitivity imaging element 143 and the light received by the low-sensitivity imaging element 144. The fluorescence image generating section 102, the background image generating section 103, and the normal image generating section 104 may be implemented by an information processing apparatus such as an CPU, or an electronic or electric circuit.

The display section 105 displays images. The display section 105 displays the fluorescence image generated by the fluorescence image generating section 102. The display section 105 displays the background image generated by the background image generating section 103. The display section 105 may simultaneously display the fluorescence image and the background image. For example, the display section 105 may display the fluorescence image in a first display region and display the background image in a second display region. The display section 105 displays the normal image generated by the normal image generating section 104. The display section 105 may include a display such as a liquid crystal display, an organic EL display or a plasma display and a display control section that controls the display. The display control section may be implemented by an information processing apparatus such as a CPU.

Although not shown, the image capturing apparatus 100 may include a storing section that stores images. The storing section may store the fluorescence image generated by the fluorescence image generating section 102. The storing section may store the background image generated by the background image generating section 103. The storing section may store, in association with each other, a fluorescence image and a background image that are captured at the same time. The storing section may store the normal image generated by the normal image generating section 104. The storing section may include a storage medium such as a flash memory and a storage control section that stores images onto the storage medium. The storage control section may be implemented by an information processing apparatus such as a CPU.

The forceps opening 111 receives a forceps 107, which is inserted thereto. The forceps opening 111 guides the forceps 107 to the end portion 121. The forceps 107 may have an end portion that comes in a variety of shapes. In addition to the forceps 107, the forceps opening 111 may receive a variety of tools to treat a biological body, which are inserted thereto. A nozzle 133 ejects water or air.

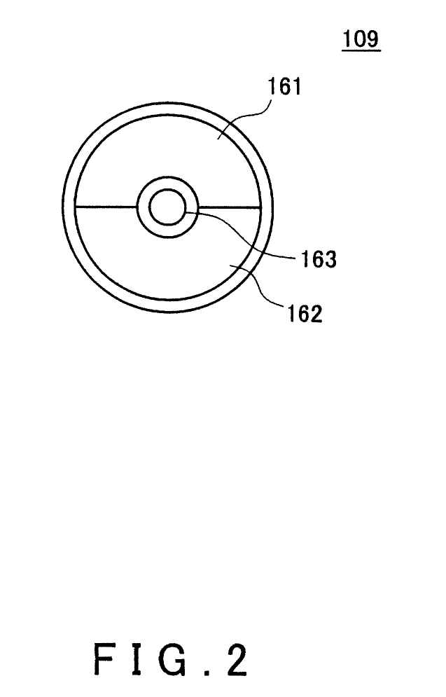

FIG. 2 illustrates an example of the rotating filter 109. The rotating filter 109 includes a first filter 161 and a second filter 162. The rotating filter 109 has the first and second filters 161 and 162 disposed on the same circumference. At the center of the rotating filter 109, a shaft 163 is provided about which the rotating filter 109 rotates. The first filter 161 transmits the white light. The first filter 161 may transmit the light emitted from the light source 108 without a change. The rotating filter 109 may not have the first filter 161 and instead has an opening. The second filter 162 transmits the wavelength range of the excitation light.

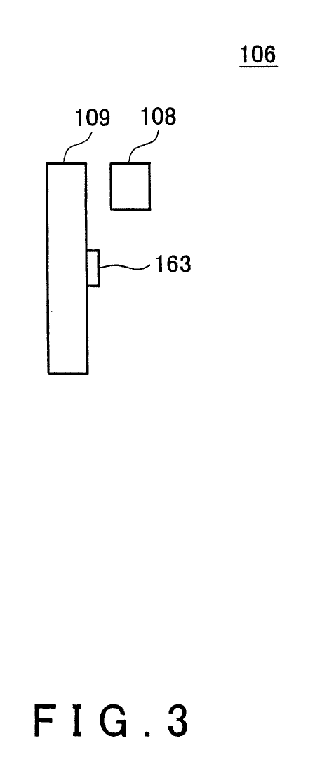

FIG. 3 illustrates an exemplary positional relationship between the light source 108 and the rotating filter 109. The emitting section 106 rotates the rotating filter 109 about the shaft 163 to align one of the first and second filters 161 and 162 with the light path of the light emitted from the light source 108. The emitting section 106 rotates the rotating filter 109, to switch the light emitted to the object between the white light and the excitation light. The emitting section 106 includes a control section that controls the light source 108 and the rotating filter 109. The control section may be implemented by an information processing apparatus such as a CPU.

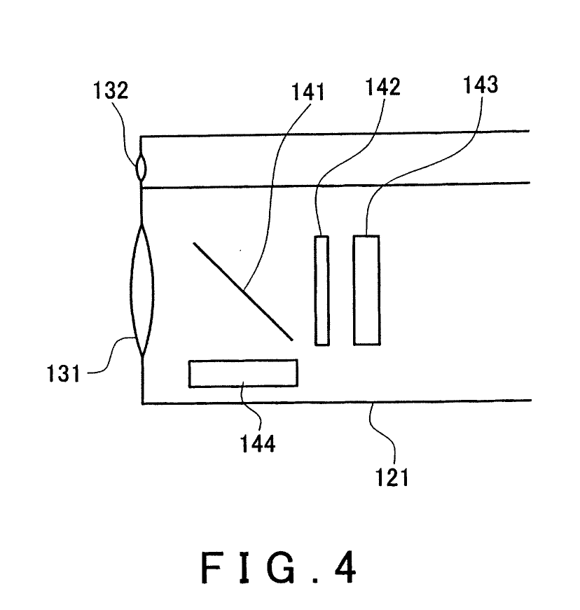

FIG. 4 illustrates an example of the image capturing section 112 provided within the end portion 121 of the endoscope 101. The lens 131 and the exit 132 are provided at the end surface 130 of the end portion 121. The optical axis of the lens 131 is substantially parallel to the longitudinal direction of the endoscope 101. The light from the object, which has passed through the lens 131, enters the light splitting section 141. The light splitting section 141 splits the incoming light into first light and second light. The light splitting section 141 splits the incoming light by transmitting part of the incoming light and reflects the rest. The light splitting section 141 transmits the first light in the direction in which the optical axis of the lens 131 extends. The light splitting section 141 reflects the second light in the direction orthogonal to the direction in which the optical axis of the lens 131 extends. The high-sensitivity imaging element 143 receives the first light produced by the light splitting section 141. The low-sensitivity imaging element 144 receives the second light produced by the light splitting section 141. The excitation light cut filter 142 is provided between the light splitting section 141 and the high-sensitivity imaging element 143. In other words, the excitation light cut filter 142 removes the wavelength range of the excitation light from the first light produced by the light splitting section 141. The high-sensitivity imaging element 143 receives the first light that has passed through the excitation light cut filter 142. Here, a lens may be provided between the light splitting section 141 and the high-sensitivity imaging element 143. In the present embodiment, the excitation light cut filter 142 and the high-sensitivity imaging element 143 are arranged along the longitudinal direction of the endoscope 101. Therefore, the end portion 121 of the endoscope 101 does not require a large size. Also, any lenses including a zoom lens can be provided along the longitudinal direction of the endoscope 101. Therefore, the end portion 121 of the endoscope 101 does not require a large size. Specifically speaking, an imaging element that is configured to capture an image based on the light that has passed through a relatively larger number of optical systems and the optical systems are arranged along the longitudinal direction of the endoscope 101 in the present embodiment. This eliminates the need of increasing the size of the end portion 121 of the endoscope 101.

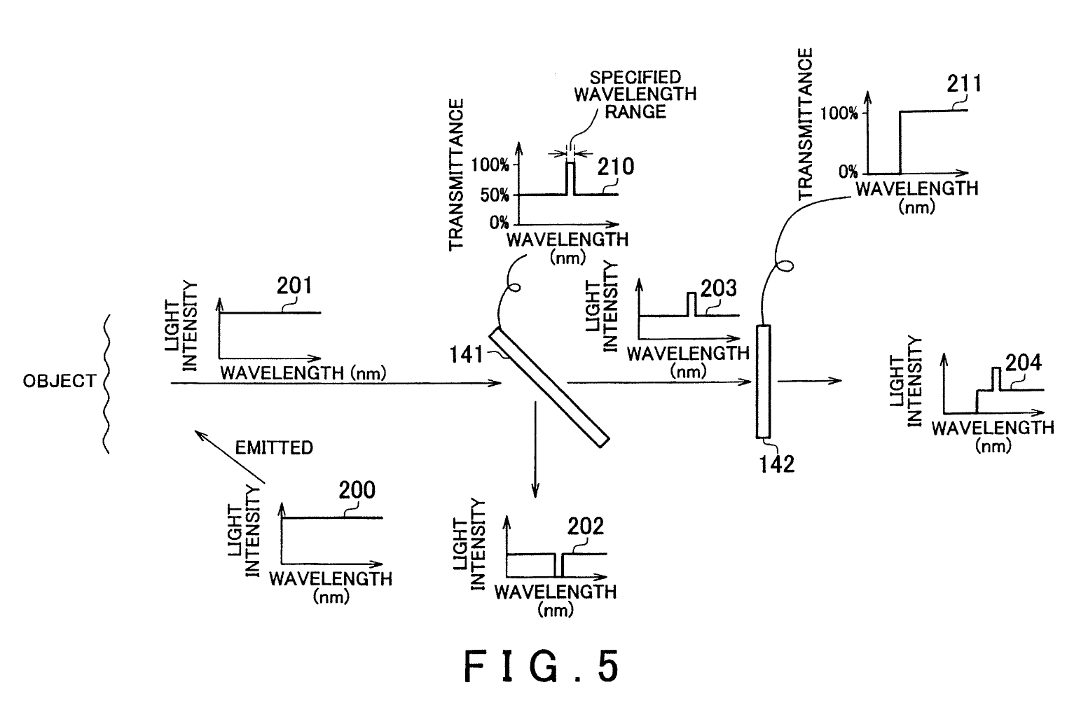

FIG. 5 illustrates, as an example, how the light splitting section 141 splits incoming light and how the excitation light cut filter 142 transmits light when the emitting section 106 emits the white light. The emitting section 106 emits white light 200 to an object under observation when the image capturing apparatus 100 is in a normal mode. Here, the white light 200 is assumed to have a constant intensity irrespective of the wavelengths. When the emitting section 106 emits the white light 200, return light 201 from the object has a constant intensity irrespective of the wavelengths in a substantially similar manner as the original white light 200. The return light 201 enters the light splitting section 141.

The light splitting section 141 splits light from an object into first light and second light in such a manner that (i) a split ratio of light in a specified wavelength range is different from a split ratio of light in a non-specified wavelength range and (ii) the second light has a smaller amount of light than the first light in the specified wavelength range. The light splitting section 141 has transmission characteristics 210 exhibiting substantially 100% transmittance for the specified wavelength range and substantially 50% transmittance for the non-specified wavelength range. Also, the light splitting section 141 has reflection characteristics exhibiting substantially zero reflectance for the specified wavelength range and substantially 50% reflectance for the non-specified wavelength range. Thus, the light splitting section 141 splits the incoming light into first light 203 that has 100% of the light in the specified wavelength range and 50% of the light in the non-specified wavelength range, which is produced by the transmission, and second light 202 that has no light in the specified wavelength range and 50% of the light in the non-specified wavelength range, which is produced by the reflection. Here, the specified wavelength range is the wavelength range of the fluorescence excited by the excitation light emitted from the emitting section 106.

The second light 202 reflected by the light splitting section 141 has substantially zero intensity in the specified wavelength range. That is to say, the second light 202 does not contain the light of the specified wavelength range. Furthermore, the intensity of the second light 202 is substantially half as low as the intensity of the return light 201 in the non-specified wavelength range. In other words, the second light 202 has substantially half as large an amount of light as the return light 201 in the non-specified wavelength range. The low-sensitivity imaging element 144 receives the second light 202.

The first light 203 transmitted by the light splitting section 141 has substantially the same intensity as the return light 201 in the specified wavelength range. That is to say, the first light 203 and the return light 201 have substantially the same amount of light in the specified wavelength range. On the other hand, the intensity of the first light 203 is substantially half as low as the intensity of the return light 201 in the non-specified wavelength range. That is to say, the first light 203 has substantially half as large an amount of light as the return light 201 in the non-specified wavelength range. The first light 203 enters the excitation light cut filter 142. The excitation light cut filter 142 has transmission characteristics 211 of removing the wavelength range equal to and lower than the wavelength of the excitation light emitted from the emitting section 106 and transmitting the wavelength range higher than the wavelength of the excitation light. The light 204 transmitted by the excitation light cut filter 142 is obtained by removing, from the first light 203, the wavelength range equal to or lower than the wavelength of the excitation light. The high-sensitivity imaging element 143 receives the light 204. The excitation light cut filter 142 may be configured to only remove the wavelength range of the excitation light emitted from the emitting section 106.

The normal image generating section 104 generates the normal image from the light received by the high-sensitivity imaging element 143 and the light received by the low-sensitivity imaging element 144. Specifically speaking, the normal image generating section 104 generates the normal image based on the values of the pixels whose luminance is equal to or lower than a predetermined luminance in the image generated by the high-sensitivity imaging element 143 and the pixels whose luminance is higher than the predetermined luminance in the image generated by the low-sensitivity imaging element 144. In other words, the normal image generating section 104 combines together the image created by the high-sensitivity imaging element 143 and the image created by the low-sensitivity imaging element 144. Consequently, the normal image generated by the normal image generating section 104 can have a wide dynamic range. The display section 105 displays the normal image generated by the normal image generating section 104.

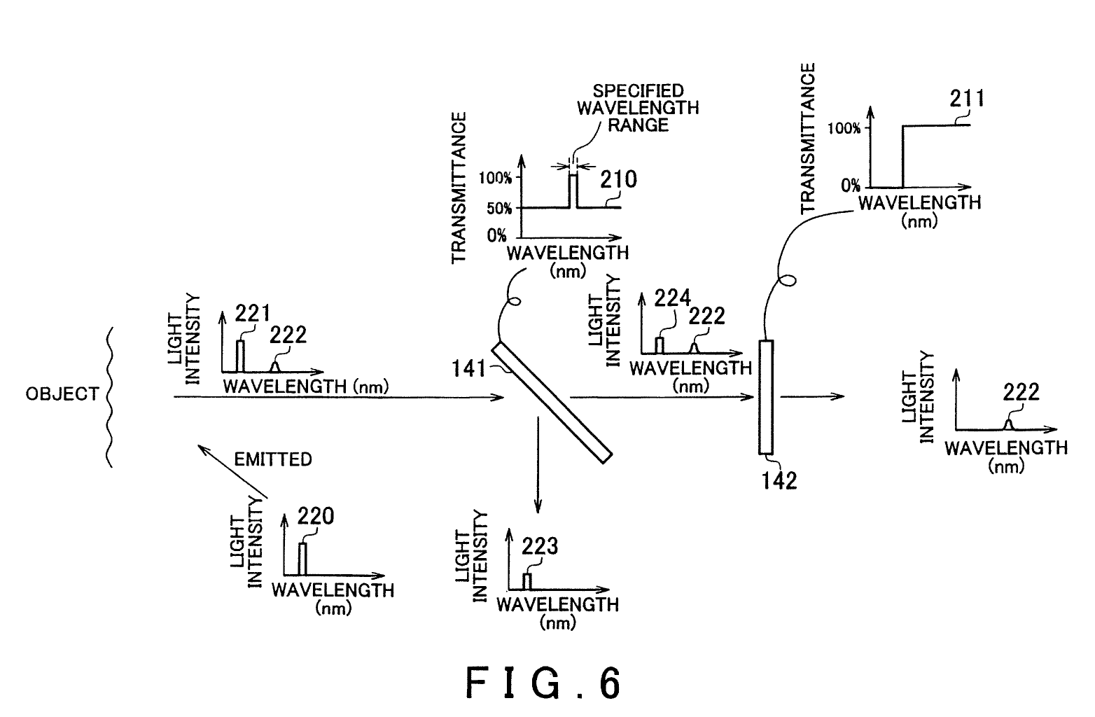

FIG. 6 illustrates, as an example, how the light splitting section 141 splits light and how the excitation light cut filter 142 transmits light when the emitting section 106 emits the excitation light. The emitting section 106 emits excitation light 220 to an object under observation when the image capturing apparatus 100 is in a fluorescence mode. When the emitting section 106 emits the excitation light 220, the return light from the object has light 221 whose wavelength range is the same as the wavelength range of the excitation light 220 and fluorescence 222 excited by the excitation light 220. The return light enters the light splitting section 141.

The light splitting section 141 splits the incoming light into first light and second light by transmitting substantially 100% of the specified wavelength range and transmitting substantially 50% of the non-specified wavelength range. The light transmitted by the light splitting section 141 is the first light. The light reflected by the light splitting section 141 is the second light. Out of the return light, the light splitting section 141 does not reflect the fluorescence 222, which has the specified wavelength range, and reflects substantially 50% of the light 221, which has the non-specified wavelength. Thus, the light 223 reflected by the light splitting section 141 has substantially half as low an intensity as the light 221. In other words, the light 223 reflected by the light splitting section 141 has substantially half as large an amount as the light 221. The light 223 is the second light. The low-sensitivity imaging element 144 receives the second light. Thus, the low-sensitivity imaging element 144 can capture a background image.

The light splitting section 141 transmits substantially 100% of the specified wavelength range, which is the fluorescence 222, and transmits substantially 50% of the non-specified wavelength range, which is the light 221. Thus, the first light transmitted by the light splitting section 141 includes the fluorescence 222, which is the specified wavelength range. The first light transmitted by the light splitting section 141 also has light 224 whose intensity is substantially half the intensity of the light 221, which has the non-specified wavelength range. In other words, the first light transmitted by the light splitting section 141 includes light 224 whose amount is substantially half the amount of the light 221. Consequently, the first light transmitted by the light splitting section 141 includes the fluorescence 222 and the light 224. The first light then enters the excitation light cut filter 142. The excitation light cut filter 142 removes, from the incoming first light, the light 224 whose wavelength range is the same as the wavelength range of the excitation light emitted from the emitting section 106. Thus, the light transmitted by the excitation light cut filter 142 is the fluorescence 222. The high-sensitivity imaging element 143 receives the fluorescence 222. In this manner, the high-sensitivity imaging element 143 can capture images solely based on fluorescence. Since the fluorescence is received by the high-sensitivity imaging element 143 in the present embodiment, the image capturing apparatus 100 can capture bright images with fluorescence, which has only a low intensity. The excitation light cut filter 142 may be alternatively configured to remove only the wavelength range of the excitation light emitted from the emitting section 106.

The fluorescence image generating section 102 generates the fluorescence image from the light received by the high-sensitivity imaging element 143. The background image generating section 103 generates the background image from the light received by the low-sensitivity imaging element 144. The display section 105 displays the fluorescence image. The display section 105 also displays the background image. The display section 105 may simultaneously display the fluorescence image and the background image. For example, the display section 105 may separately display the fluorescence image in a first display region and the background image in a second display region. Also, the display section 105 may display the fluorescence image on the background image. In this case, the display section 105 may display, on the background image, only a region illuminated by the fluorescence, out of the fluorescence image. The display section 105 may display one of the fluorescence image and the background image.

The image capturing apparatus 100 may switch the operational mode between the normal mode and the fluorescence mode according to a user's instruction or automatically. In the case of automatic switching, the image capturing apparatus 100 may periodically switch the operational mode at predetermined time intervals. For example, the image capturing apparatus 100 may alternately switch the operational mode according to the image capturing periods of the high-sensitivity and low-sensitivity imaging elements 143 and 144.

As described above, the present embodiment includes a light splitting section that splits light from an object into first light and second light in such a manner that (i) a split ratio of light in a specified wavelength range is different from a split ratio of light in a non-specified wavelength range and (ii) the second light has a smaller amount of light than the first light in the specified wavelength range, receives the first light at a high-sensitivity imaging element, and receives the second light at a low-sensitivity imaging element. Therefore, the image capturing apparatus 100 can produce the fluorescence image and the background image when emitting the excitation light. Furthermore, when emitting the white light, the image capturing apparatus 100 can produce the normal image having a wide dynamic range. Here, an information processing apparatus such as a CPU may function as the image capturing apparatus 100 by executing a predetermined program.

As an alternative example to the above embodiment, the light splitting section 141 may split the incoming light into first light having 100% of the light in the specified wavelength range and 50% of the light in the non-specified wavelength range, which is produced by reflection, and second light having no light in the specified wavelength range and 50% of the light in the non-specified wavelength range, which is produced by transmission. The light splitting section 141 splits the light the non-specified wavelength range with the ratio of the first light:the second light=50:50 in the above embodiment, but may split the light in the non-specified wavelength range with a different ratio. For example, the light splitting section 141 may split the light in the non-specified wavelength range with the ratio of the first light:the second light=40:60. In this case, it is preferable that the second light has a larger amount of light than the first light for the light in the non-specified wavelength range. Similarly, the light splitting section 141 splits the light of the specified wavelength range with the ratio of first light:second light=100:0 in the present embodiment, but may adopt a different ratio. For example, the light splitting section 141 may split the light in the specified wavelength range with the ratio of first light:second light=90:10. In this case, the first light may have a larger amount of light than the second light in the specified wavelength range.

Although some aspects of the present invention have been described by way of exemplary embodiments, it should be understood that those skilled in the art might make many changes and substitutions without departing from the spirit and the scope of the present invention which is defined only by the appended claims.

The claims, specification and drawings describe the processes of an apparatus, a system, a program and a method by using the terms such as operations, procedures, steps and stages. When a reference is made to the execution order of the processes, wording such as “before” or “prior to” is not explicitly used. The processes may be performed in any order unless an output of a particular process is used by the following process. In the claims, specification and drawings, a flow of operations may be explained by using the terms such as “first” and “next” for the sake of convenience. This, however, does not necessarily indicate that the operations should be performed in the explained order.

What is claimed is:

1. An image capturing apparatus comprising:
a light splitting section that splits light from an object into first light and second light in such a manner that (i) a split ratio of light in a specified wavelength range is different from a split ratio of light in a non-specified wavelength range and (ii) the second light has a smaller amount of light than the first light in the specified wavelength range;
a high-sensitivity imaging element that receives the first light; and
a low-sensitivity imaging element that receives the second light, the low-sensitivity imaging element having a lower sensitivity than the high-sensitivity imaging element.

2. The image capturing apparatus as set forth in claim 1, wherein
the light splitting section splits the light from the object into the first light and the second light in such a manner that the second light has a smaller amount of light in the specified wavelength range than the first light and the second light has substantially the same amount of light as the first light in the non-specified wavelength range.

3. The image capturing apparatus as set forth in claim 1, further comprising
an image generating section that generates a first image of the object from the first light received by the high-sensitivity imaging element and generates a second image of the object from the second light received by the low-sensitivity imaging element.

4. The image capturing apparatus as set forth in claim 1, further comprising
an image generating section that generates an image of the object from the first light received by the high-sensitivity imaging element and the second light received by the low-sensitivity imaging element.

5. The image capturing apparatus as set forth in claim 1, further comprising:
an emitting section that emits excitation light to excite fluorescence having the specified wavelength range; and
an excitation light cut filter that is positioned between the light splitting section and the high-sensitivity imaging element, the excitation light cut filter removing a wavelength range of the excitation light, wherein
the high-sensitivity imaging element receives the fluorescence that has passed through the excitation light cut filter.

6. The image capturing apparatus as set forth in claim 5, further comprising:
a fluorescence image generating section that generates a fluorescence image from the first light received by the high-sensitivity imaging element, when the emitting section emits the excitation light; and
a background image generating section that generates a background image from the second light received by the low-sensitivity imaging element, when the emitting section emits the excitation light.

7. The image capturing apparatus as set forth in claim 6, wherein
the emitting section switches light emitted therefrom between the excitation light and visible light having a wider wavelength range than the excitation light, and
the image capturing apparatus further comprises
a normal image generating section that generates a normal image from the first light received by the high-sensitivity imaging element and the second light received by the low-sensitivity imaging element, when the emitting section emits the visible light.

8. The image capturing apparatus as set forth in claim 7, wherein
the normal image generating section generates the normal image based on (i) pixels, in an image captured by the high-sensitivity imaging element, whose luminance is equal to or lower than a predetermined luminance and (ii) pixels, in an image captured by the low-sensitivity imaging element, whose luminance is higher than the predetermined luminance.

9. The image capturing apparatus as set forth in claim 1, wherein
the image capturing apparatus is an endoscope apparatus including an endoscope, and
the light splitting section, the high-sensitivity imaging element, and the low-sensitivity imaging element are provided in an end portion of an insertion portion of the endoscope.

10. The image capturing apparatus as set forth in claim 9, wherein
the light splitting section supplies the first light in a longitudinal direction of the endoscope and supplies the second light in a direction substantially orthogonal to the longitudinal direction of the endoscope.
